(19) United States
(12) Patent Application Publication
(10) Pub. No.: US 2018/0340610 A1
(43) Pub. Date: Nov. 29, 2018

(54) POWER SPLIT GEARBOX AND METHOD FOR OPERATING A POWER SPLIT GEARBOX

(71) Applicant: ZF Friedrichshafen AG, Friedrichshafen (DE)

(72) Inventor: Jürgen LEGNER, Friedrichshafen (DE)

(73) Assignee: ZF Friedrichshafen AG, Friedrichshafen (DE)

(21) Appl. No.: 15/777,924

(22) PCT Filed: Oct. 25, 2016
(86) PCT No.: PCT/EP2016/075604

§ 371 Date: May 22, 2018

(30) Foreign Application Priority Data
Nov. 25, 2015 (DE) 10 2015 223 250.6

(51) Int. Cl. F16H 61/421; F16H 47/04; F16H 61/431; F16H 61/439; F16H 39/10

(52) U.S. Cl. CPC F16H 61/421; F16H 47/04; F16H 39/10; F16H 61/439; F16H 61/431

(57) ABSTRACT

A power split gearbox with a secondary coupling and a drive range has an adjusting unit (13), where its position control valve (15) interacts with the cylinder (14) in such a way that, during a de-energized condition of the position control valve (15), the cylinder (14) adjusts the second hydraulic unit (9) so that the unit has a zero stroke volume.

This application is a National Stage completion of PCT/EP2016/075604 filed Oct. 25, 2016, which claims priority from German patent application serial no. 10 2015 223 250.6 filed Nov. 25, 2015.

### FIELD OF THE INVENTION

The invention relates to a power split gearbox with a secondary.

### BACKGROUND OF THE INVENTION

DE 102013204746A1 teaches a power split gearbox with a secondary coupling, meaning that the summing gearbox has three shafts, whereby the first shaft is in an operating connection with the driveshaft, and the second shaft is in an operating connection with a first hydraulic unit, and the third shaft is in an operating connection with a second hydraulic unit. The first hydraulic unit and the second hydraulic unit are positioned in a common bay for the adjustment of the stroke volume, whereby a first limit of the drive range is reached when the flow volume of the hydraulic pump equals zero and the stroke of the hydraulic motor is at maximum, and a second limit of the drive range is reached when the flow volume of the hydraulic pump is at maximum and the stroke of the hydraulic motor equals zero. Depending on the control of the stroke volume adjustment, uncontrolled drive situations may occur if, for instance, the vehicle is at maximum speed and the stroke volume adjustment changes very fast towards minimum speed.

The DE 102013200390A1 teaches a control device for adjusting the hydraulic units of a power split gearbox.

### SUMMARY OF THE INVENTION

The object of the present invention is to provide power split gearbox, in which the operational safety is increased and uncontrollable drive situations are eliminated.

This object is achieved with the generic power split box which has the distinctive characteristic features of the main claim.

In accordance with the invention, the power split gearbox with a secondary coupling has an adjusting device for adjusting the stroke volume of the first and the second hydraulic units which adjusts the stroke volume depending on the strength of an electrical current. The adjusting device is designed in such a way that, in a de-energized state, the hydraulic unit which is in an operating connection with the output of the power split gearbox is adjusted so that it has no stroke volume. If this hydraulic unit operates as a hydraulic motor, it does not have in this de-energized state any displacement. A de-energized state may occur, for example, when the entire electrical supply of the vehicle fails.

There is in addition a possibility in a de-energized state to disengage a clutch which separates the driveshaft of the power split gearbox from the summing gearbox, or a shaft of the combined gearbox, respectively, so that the hydraulic unit which is connected with the output cannot support a torque.

In addition, it is advantageous if the other hydraulic unit, for instance a hydraulic pump, is adjusted in a de-energized state to its maximum stroke volume.

In a power split gearbox, in which there are no more shift elements between the summing gearbox and the output, for example, to shift additional drive ranges, it is therefore not possible in a single-range gearbox to disconnect the powertrain between the output and the hydraulic unit which is in an operating connection with the output. If the vehicle is now at high speed and due to a defect, for instance the failure of the electric system, the hydraulic unit which is an operating connection with the output would be adjusted to its maximum stroke volume, and this would lead to an uncontrolled deceleration of the wheels and a slippage of the vehicle. However, in a de-energized condition, for instance through a defect in the electric system, the hydraulic unit which is an operating connection with the output, which is adjusted to the stroke volume zero and the clutch, which is positioned between the summing gearbox and the driveshaft, is actuated towards disengagement and the other hydraulic unit is adjusted to its maximum stroke volume, a torque cannot be supported anymore at the hydraulic unit which is in operating connection with the output, thus with the motor hydraulic unit, which therefore avoids slippage of the vehicle wheels.

Preferably, the adjusting unit has an adjusting cylinder to adjust the stroke volume and a position control valve cooperating therewith . The position control valve can have a control magnet, which, in a de-energized condition, cooperates with the position control valve so that the adjusting cylinder adjusts the second hydraulic unit such that it has a zero stroke volume. The condition where the second hydraulic unit has the zero stroke volume, and the first hydraulic unit has the maximum stroke volume, is also referred to as the end velocity position. The position control valve is therefore designed so that it adjusts, in the de-energized state, the hydraulic units position for the final speed and, for the full-current position, meaning at maximum current, is adjusted to the position at the hydraulic units for starting. Hereby, also the control ability of the position control valve is improved, because the hysteresis diminishes at a high current. Thus, a very accurate adjustment of the stroke volume is especially possible at the starting point. Additional characteristics can be seen in the drawing descriptions.

### BRIEF DESCRIPTION OF THE DRAWINGS

These show:

FIG. 1 a power split gearbox with a drive range for forward and a drive range for reverse; and

FIG. 2 a hydraulic schematic to control the stroke volume of the power split gearbox as in FIG. 1.

### DETAILED DESCRIPTION OF THE PREFERRED EMBODIMENTS

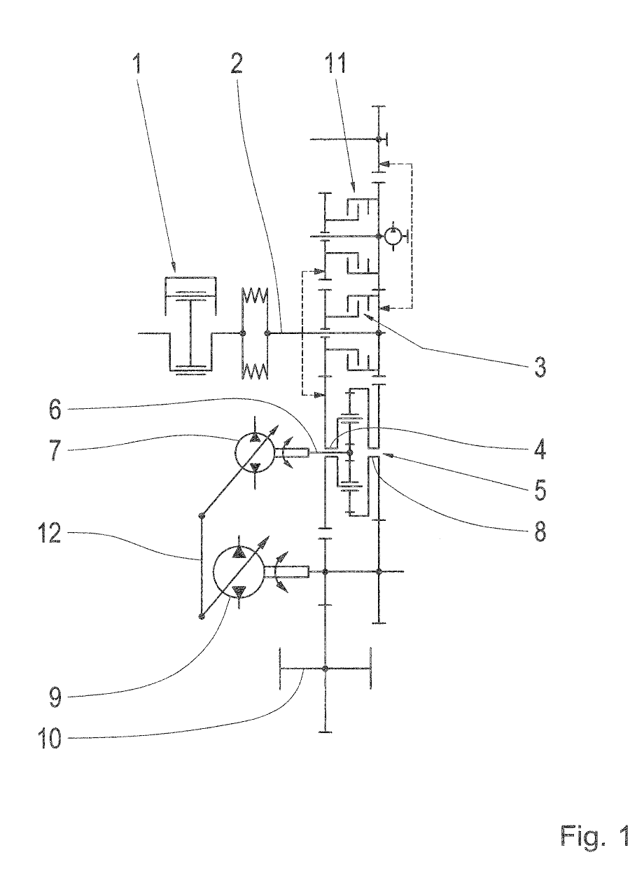

FIG. 1

A drive motor 1, for instance a combustion engine, drives the driveshaft 2.

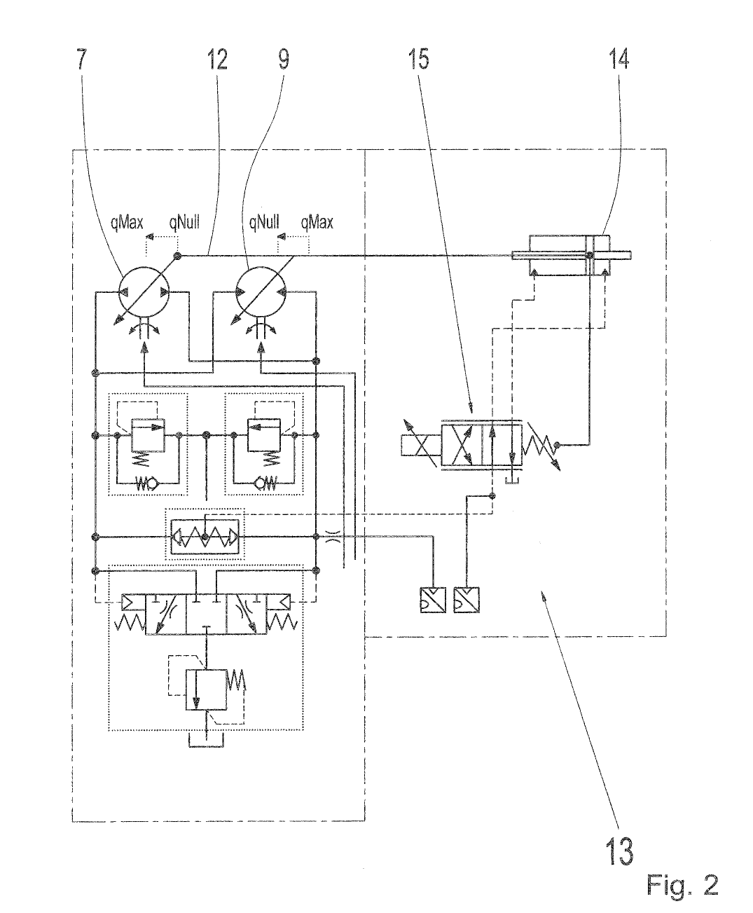

The driveshaft 2 drives a first shaft 4 of a summing gearbox 5 via a clutch for forward drive 3. The second shaft 6 of the summing gearbox 5 is connected with the first hydraulic unit 7. The first hydraulic unit 7 is also defined as pump. The third shaft 8 of the summing gearbox 5 is an operating connection with the second hydraulic unit 9 and the output shaft 10, The second hydraulic unit 9 is also defined as a motor. Through the clutch, the output shaft 10 can be driven for a reverse drive 11 in the opposite direction. The first hydraulic unit 7 and the second hydraulic unit 9 are connected through a common yoke 12 through which the stroke volume of the first hydraulic unit 7 and the second hydraulic unit 9 can be adjusted. The yoke 12 interacts together with the adjustment device which is schematically presented in FIG. 2. The additional details of the summing gearbox 5 and the function of the adjustment of the first hydraulic unit 7 and the second hydraulic unit can be seen in DE 102013204746A1.

FIG. 2

The adjustment device 13 has a cylinder 14 which is connected with the yoke 12 and which adjusts the stroke volume of the first hydraulic unit 7 and the second hydraulic unit 9. The cylinder 14 operates together with a position control valve 15 which, depending on applying an electrical current or its current strength, respectively, adjusts the position of the cylinder 14. The position control valve 15 cooperates with the cylinder 14 so that in a de-energized state, meaning when no current is applied to the position control valve 15, the cylinder 14 is adjusted so that the second hydraulic unit 9 is adjusted to a zero stroke volume and the first hydraulic unit 7 to the maximum stroke volume. To start the power split gearbox as in FIG. 1, a maximum current is applied to the position control valve 15, whereby the cylinder 14 is adjusted so that the second hydraulic unit 9 is adjusted to its maximum stroke volume and the first hydraulic unit 7 is adjusted to its minimum stroke volume. The function of the additional valves which interact together with the first hydraulic unit 7 and the second hydraulic unit 9 can be seen in DE 1020132003990A1.

If the vehicle is now at high speed and a defect causes a de-energized condition and the position control valve 15 is without current, the cylinder 14 is adjusted so that the second hydraulic unit 9 is adjusted to a zero stroke volume and the first hydraulic unit 7 is adjusted to the maximum stroke volume, and at the same the clutch for forward drive 3 and the clutch for the reverse drive 11 are disengaged in the opening direction, so that the second hydraulic unit 9 cannot support torque, and that the output shaft 10 is not decelerated to the extent that this situation will cause uncontrolled sliding of the vehicle. Thus, driving safety is ensured even if an electric defect occurs.

### REFERENCE CHARACTERS

1 Drive Motor
2 Drive Shaft
3 Clutch, Forward Drive
4 First Shaft
5 Summing Gearbox
6 Second Shaft
7 First Hydraulic Unit
8 Third Shaft
9 Second Hydraulic Unit
10 Output Shaft
11 Clutch, Reverse Drive
12 Bay
13 Adjusting Device
14 Cylinder
15 Position Control Valve

1-9. (canceled)

10. A power split gearbox comprising:
a drive shaft (2) being connectable with a drive motor (1),
an output shaft (10) being connectable with vehicle wheels,
a first hydraulic unit (7) having an adjustable stroke volume and being operable as either a motor or a pump,
an adjustable second hydraulic unit (9) having an adjustable stroke volume and being be operable as either a motor or a pump,
a summing gearbox (5) having a first shaft (4), a second shaft (6) and a third shaft (8), the first shaft (4) being operably connected, via a clutch (3), with the drive shaft (2), the second shaft (6) being operably connected with the first hydraulic unit (7), and the third shaft (8) being operably connected with the second hydraulic unit (9) and the output shaft (10),
an adjusting device (13) being powered by an electrical current to adjust the stroke volume of the first hydraulic unit (7) and the stroke volume of the second hydraulic unit (9), and
the adjusting unit (13), in a de-energized condition, adjusting the second hydraulic unit (9) to a zero stroke volume.

11. The power split gearbox according to claim 10, wherein the adjusting unit (1), in the de-energized condition, adjusts the first hydraulic unit (7) to a maximum stroke volume.

12. The power split gearbox according to claim 10, wherein the clutch (3) is activated towards disengagement, during the de-energized condition of the adjusting unit (13).

13. The power split gearbox according to claim 10, wherein the first hydraulic unit (7) and the second hydraulic unit (9) are coupled, via a common yoke (12), by which the stroke volume of the first and the second hydraulic units are adjusted.

14. The power split box according to claim 10, wherein the adjusting unit has an adjustment cylinder (14) for adjusting the stroke volumes of the first and the second hydraulic units and a position control valve (15) cooperating therewith, the position control valve has a regulating magnet which, in the de-energized condition, interacts with the position control valve such that the adjusting cylinder (14) adjusts the second hydraulic unit (9) to the zero stroke volume.

15. The power split box according to claim 11, wherein the stroke volume of the first hydraulic unit (7) and the stroke volume of the second hydraulic unit (9), in the de-energized condition of the adjusting unit (14), corresponds to a stroke volume of a maximum rotational speed of the output shaft.

16. A method of operating a power split box with a drive shaft (2), which is connectable with a drive motor (1) and a drive shaft (10) that is connectable with vehicle wheels, a hydraulic unit (7) has an adjustable stroke volume which is operable either as a motor or as a pump, a second hydraulic unit (9) has an adjustable stroke volume which is operable either as a motor or as a pump, and a summing gearbox (5) with a first shaft (4) and a second shaft (6) and a third shaft (8), the first shaft (4) being operably connected, via a clutch (3), with the drive shaft (2), the second shaft (6) being operably connected with the first hydraulic unit (7), and the third shaft (8) being operably connected with the second hydraulic unit (9) and the output shaft (10), and an adjustment device (13) being operated through electric current for adjustment of the stroke volume of the first hydraulic unit (7) and the stroke volume of the second hydraulic unit (9), the method comprising:
always adjusting the second hydraulic unit (9), with the adjusting device (13), to a zero stroke volume when the adjusting device (13) is de-energized.

17. The method of operating the power split box according to claim 16, further comprising, when no current is applied to the adjusting unit (13), always adjusting the first hydraulic unit (7), with the adjusting unit (13), to a maximum stroke volume.

18. The method of operating the power split box according to claim 17, further comprising actuating the clutch (3) in a disengaging direction when the adjusting device (13) is de-energized.

19. A power split gearbox comprising:
a drive shaft (2) being connectable to a drive motor (1), and an output shaft (10) being connectable to vehicle wheels;
first and second hydraulic units (7, 9), each of the first and the second hydraulic units being operable as either a motor or a pump, and having an adjustable stroke volume;
a summing gearbox (5) having first, second and third shafts (4), the first shaft (4) being operably connected, via a clutch, to the drive shaft (2), the second shaft (6) being connected to the first hydraulic unit (7), and the third shaft (8) being operably connected to the second hydraulic unit (9) and the output shaft (10);
an adjusting device (13) being connected to the first and the second hydraulic units; and
the adjusting device being electrically actuatable for adjusting the stroke volumes of the first and the second hydraulic units such that, in a de-energized condition of the adjusting device, the second hydraulic unit is adjusted to a zero stroke volume.
